(19) United States
(12) Patent Application Publication
(10) Pub. No.: US 2013/0104350 A1
(43) Pub. Date: May 2, 2013

(54) MONEY CLIP

(71) Applicant: DE LINDSAY GMBH, Edingen-Neckarhausen (DE)

(72) Inventor: Matthias Vlasdeck, Badenheim (DE)

(73) Assignee: DE LINDSAY GMBH, Edingen-Neckarhausen (DE)

(21) Appl. No.: 13/659,341

(22) Filed: Oct. 24, 2012

(30) Foreign Application Priority Data
Oct. 28, 2011 (DE) 20 2011 107 340.1

(51) Int. Cl. B42F 1/02; A45D 42/00; F16B 2/20

(52) U.S. Cl. 24/489; 24/455

(57) ABSTRACT

The invention relates to a money clip for storing banknotes or comparable flatly formed items, including a base plate and at least one retaining leg disposed on the base plate, wherein the retaining leg is formed such that it exerts a clamping function or a retention force in the direction of the base plate, wherein at least one region of the base plate or at least one region of the retaining leg is formed as a mirror.

### CROSS-REFERENCE TO RELATED APPLICATION

The present patent document relates to and claims priority to earlier filed German Utility Model Serial No. 202011107340, filed on Oct. 28, 2011, the entire contents of which are incorporated herein by reference.

### BACKGROUND OF THE INVENTION

1. Field of the Invention

This patent document relates generally to a money clip for storing banknotes or comparable flatly formed items, including a base plate and at least one retaining leg disposed on the base plate, wherein the retaining leg is formed such that it exerts a clamping function or a retention force in the direction of the base plate.

2. Background of the Related Art

Such money clips are known in a plurality from the prior art. Thus, WO 2007/108800 describes a money clip in combination with a storage device for check cards, EC cards, credit cards or comparable electronic cards. However, it is disadvantageous in the known money clips that the range of functions thereof is restricted to retention of banknotes or optionally storage of check cards, EC cards, credit cards or comparable electronic cards. Therefore, it is the object of the present invention to provide a money clip of the initially mentioned kind, which expands the possibilities of use thereof.

### SUMMARY OF THE INVENTION

A money clip according to one embodiment of the invention for storing banknotes or comparable flatly formed items includes a base plate and at least one retaining leg disposed on the base plate, wherein the retaining leg is formed such that it exerts a clamping function or a retention force in the direction of the base plate. Furthermore, at least one region of the base plate is formed as a mirror or comprises a mirror. By the formation of the at least one region as a mirror, a further possibility of use of the money clip arises, namely as a small mirror, which can for example serve as a make-up mirror for ladies. Thus, according to the invention, there is not only the possibility of storing and transporting banknotes by means of the money clip, but it likewise serves as a mirror. Advantageously, an additional hand mirror does not have to be carried along besides the money clip.

A money clip according to another embodiment of the invention for storing banknotes or comparable flatly formed items includes a base plate and at least one retaining leg disposed on the base plate, wherein the retaining leg is formed such that it exerts a clamping function or a retention force in the direction of the base plate. Furthermore, at least one region of the retaining leg is formed as a mirror or comprises a mirror. By the formation of the at least one region as a mirror, a further possibility of use of the money clip arises, namely as a small mirror, which can for example serve as a make-up mirror for ladies. Thus, according to the invention, there is not only the possibility of storing and transporting banknotes by means of the money clip, but it likewise serves as a mirror. Advantageously, an additional hand mirror does not have to be carried along besides the money clip.

In an advantageous development of the money clip according to the invention, the retaining leg is connected to the base plate in hinged manner. Thereby, it is for example possible that the mirror is disposed on a face of the retaining leg facing the base plate. According to this embodiment, the mirror is protected from scratches or other damages because in the folded-in state of the retaining leg, it comes to lie between it and the base plate of the money clip.

In a further advantageous development of the money clip according to the invention, a receiving device for check cards, EC cards, credit cards or comparable electronic cards is formed on a face of the base plate opposite to the retaining leg. Thereby, advantageously, a further possibility of use of the money clip according to the invention is constituted. Besides the basic functions as a money clip and mirror, the money clip according to the invention can also be used for storing and transporting the mentioned electronic cards.

In further advantageous developments of the money clip according to the invention, the mirror is formed as a separate element to be attached to the base plate and/or the retaining leg. Therein, the mirror can be composed of a mirror foil or a flatly formed plastic or metallic element with at least one mirrored surface. However, it is also possible that the mirror is composed of a high gloss polished metallic element. Furthermore, there is the possibility that the base plate and/or the retaining leg are composed of metal or a metal alloy and the region for forming the mirror is high gloss polished. Finally, there is additionally the possibility that the region of the base plate and/or the retaining element for forming the mirror is chrome-plated or coated with a mirror varnish. In case the mirror is composed of a flatly formed plastic or metallic element with at least one mirrored surface, it can be adhered, screwed or otherwise connected to the corresponding region of the money clip. Thus, there is also the possibility of forming the mentioned plastic or metallic element such that it can be fitted on the money clip. In embodiments of the money clip according to the invention, in which a storage device for check cards and the like is provided, the mirrored element can be configured such that it can be inserted into the storage device of the check cards and stored there.

### BRIEF DESCRIPTION OF THE DRAWINGS

Further details, features and advantages of the invention are explained in more detail in the embodiment described below and illustrated in the figures, in which:

FIG. 1 is a schematically illustrated lateral top view of a money clip according to the invention according to a first embodiment;

FIG. 2 is a further schematic illustration of the money clip according to the invention according to FIG. 1 in a lateral view from below;

FIG. 3 is a further schematic illustration of the money clip according to the invention according to FIG. 1 with an opened retaining leg;

FIG. 4 is a schematically illustrated lateral top view of a money clip according to the invention with an opened retaining leg according to a second embodiment; and

FIG. 5 is a schematically illustrated lateral top view of a money clip according to the invention with an opened retaining leg according to a third embodiment.

### DESCRIPTION OF THE PREFERRED EMBODIMENTS

The present invention will now be described more fully hereinafter with reference to the accompanying figures, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

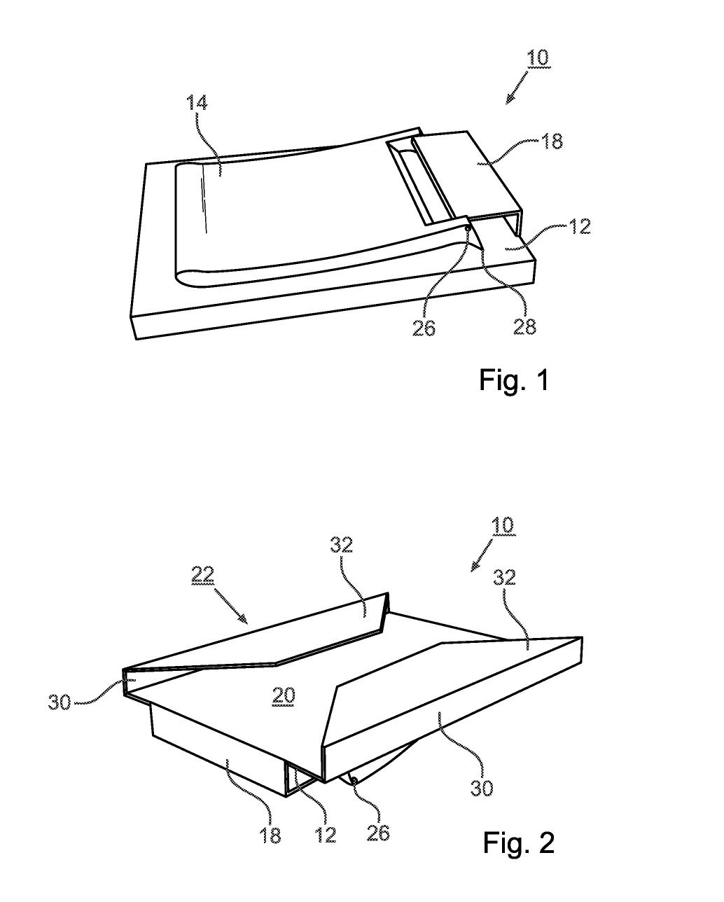

FIG. 1 shows a schematically illustrated lateral top view of a money clip 10. One recognizes that the money clip 10 includes a base plate 12, on which a retaining leg 14 is disposed. Therein, the retaining leg 14 is connected to the base plate 12 via a retaining element 18 via a hinge connection 26. In the illustrated embodiment, the retaining leg 14 is formed such that it exerts a clamping function in the direction the base plate 12 such that banknotes or comparable flatly formed items can be securely retained. Furthermore, one recognizes that the retaining leg 14 has a detent lobe 28 in the region of the hinge connection 26, which serves for secure retention of the retaining leg 14 on the base plate 12 in the folded-in state. However, it is also possible to resiliently form the retaining leg 12 with respect to the base plate 12.

FIG. 2 shows a further schematic illustration of the money clip 10 according to FIG. 1 in a lateral view from below. One recognizes that a receiving device 22 for check cards, EC cards, credit cards or comparable electronic cards is formed on a face 20 of the base plate 12 opposite to the retaining leg 14. Therein, the receiving device 22 includes respectively opposing sidewalls 30 extending approximately perpendicularly from the longitudinal sides of the base plate 12, which have inward pointing retaining faces 32 emanating from the sidewalls 30 in approximately orthogonal angle at their ends opposing the face 20. The face 20 of the base plate 12, the sidewalls 30 as well as the respective retaining faces 32 form a gap for receiving the mentioned check cards, credit cards or comparable electronic cards.

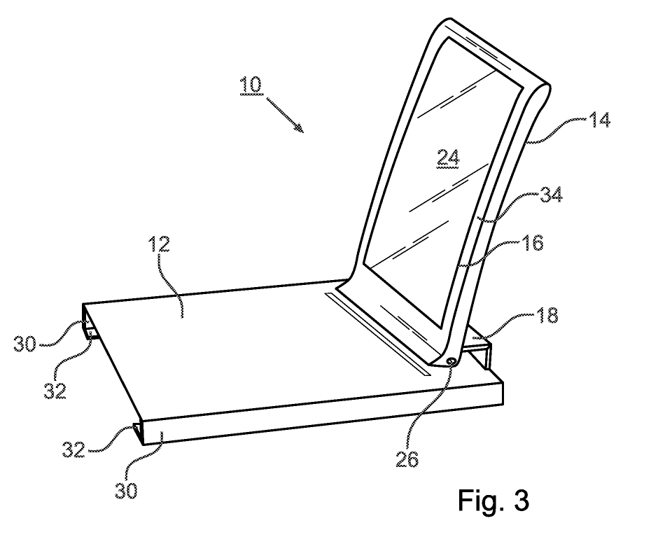

FIG. 3 shows a further schematic illustration of the money clip 10 according to FIG. 1 with an opened retaining leg 14. One recognizes that a region 16 of the retaining leg 14 is formed as a mirror 24. Therein, the mirror 24 is disposed on a face 34 of the retaining leg 14 facing the base plate 12. In the illustrated embodiment, the mirror 24 is formed as a separate element, namely as a mirror foil attached to the face 34 of the retaining leg 14.

Besides the embodiment of the money clip 10 illustrated in FIG. 3, the mirror 24 can also be disposed at other locations of the money clip 10, namely on the base plate 12 or on the exterior of the retaining leg 14. Furthermore, there is the possibility of disposing multiple mirrors 24 on the money clip 10.

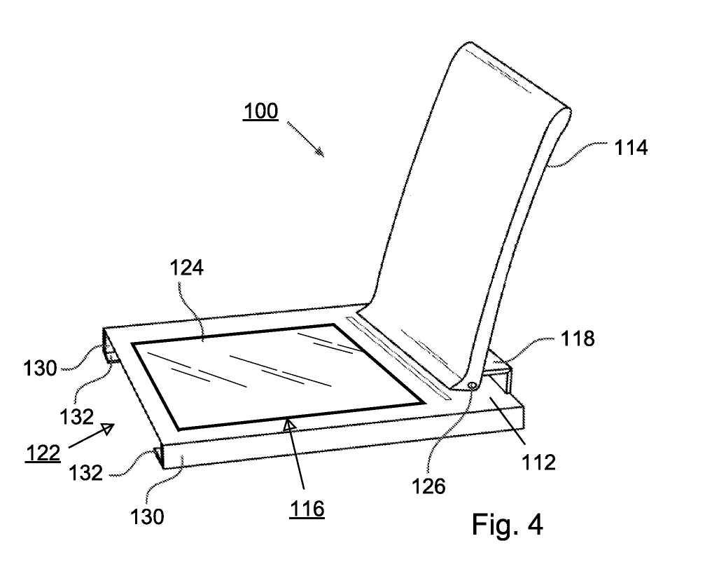

FIG. 4 shows a second embodiment of the money clip 100, wherein here a region 116 of a base plate 112 is formed as a mirror 124. The money clip 100 is illustrated with an opened retaining leg 114. In the illustrated embodiment, the mirror 124 is formed as a separate element, namely as a mirror foil attached to a surface of the base plate 112 facing the retaining leg 114.

Therein, the retaining leg 114 is connected to the base plate 112 via a retaining element 118 and a hinge connection 126. In the illustrated embodiment, the retaining leg 114 is formed such that it exerts a clamping function in the direction of the base plate 112, such that banknotes or comparable flatly formed items can be securely retained. On a face 120 of the base plate 112 opposite to the retaining leg 114, a receiving device 122 for check cards, EC cards, credit cards or comparable electronic cards is formed. Therein, the receiving device 122 includes respectively opposing sidewalls 130 extending approximately perpendicularly from the longitudinal sides of the base plate 112, which have inward pointing retaining faces 132 emanating from the sidewalls 130 in an approximately orthogonal angle at their ends opposing the face 120. The face 120 of the base plate 112, the sidewalls 130 as well as the respective retaining faces 132 form a gap for receiving the mentioned check cards, credit cards or comparable electronic cards.

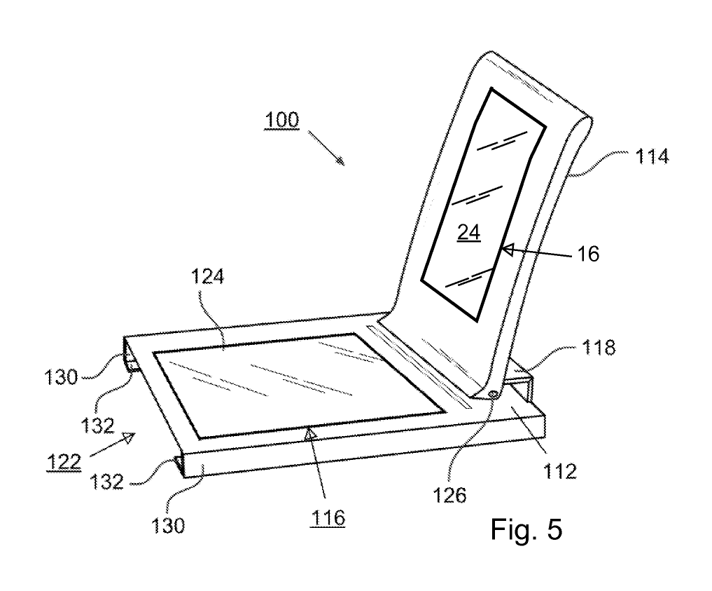

FIG. 5 shows a third embodiment of the money clip 100, wherein here a region 116 of a base plate 112 and a region 16 of the retaining leg 114 comprise a mirror 124 and a mirror 24, respectively. The money clip 100 is illustrated with an opened retaining leg 114. In the illustrated embodiment, the mirrors 124 and 24 are formed as separate elements, namely as mirror foils attached on the one hand to a surface of the base plate 112 facing the retaining leg 114 and on the other hand attached to the surface of the retaining leg 114 facing the base plate 112.

Further, the retaining leg 114 is connected to the base plate 112 via a retaining element 118 and a hinge connection 126. In the illustrated embodiment, the retaining leg 114 is formed such that it exerts a clamping function in the direction of the base plate 112, such that banknotes or comparable flatly formed items can be securely retained. On a face 120 of the base plate 112 opposite to the retaining leg 114, a receiving device 122 for check cards, EC cards, credit cards or comparable electronic cards is formed. Therein, the receiving device 122 includes respectively opposing sidewalls 130 extending approximately perpendicularly from the longitudinal sides of the base plate 112, which have inward pointing retaining faces 132 emanating from the sidewalls 130 in an approximately orthogonal angle at their ends opposing the face 120. The face 120 of the base plate 112, the sidewalls 130 as well as the respective retaining faces 132 form a gap for receiving the mentioned check cards, credit cards or comparable electronic cards.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof.

While the present invention is described herein in detail in relation to specific aspects, it is to be understood that this detailed description is only illustrative and exemplary of the present invention and is made merely for purposes of providing a full and enabling disclosure of the present invention and to provide the best mode contemplated by the inventor or inventors of carrying out the invention. The detailed description set forth herein is not intended nor is to be construed to limit the present invention or otherwise to exclude any such other embodiments, adaptations, variations, modifications, and equivalent arrangements of the present invention.

What is claimed is:

1. A money clip for storing banknotes or comparable flatly formed items, including a base plate and at least one retaining leg disposed on the base plate, wherein the retaining leg is formed such that it exerts a clamping function or a retention force in the direction of the base plate, wherein at least one region of the base plate is formed as a mirror or comprises a mirror.

2. The money clip according to claim 1, wherein additionally at least one region of the retaining leg is formed as a mirror or comprises a mirror.

3. The money clip according to claim 1, wherein the retaining leg is connected to the base plate in hinged manner.

4. The money clip according to claim 1, wherein a receiving device for check cards, EC cards, credit cards or comparable electronic cards is formed on a face of the base plate opposite to the retaining leg.

5. The money clip according to claim 1, wherein the mirror is formed as a separate element to be attached to the base plate.

6. The money clip according to claim 1, wherein the mirror is composed of a mirror foil or a flatly formed plastic or metallic element with at least one mirrored surface.

7. The money clip according to claim 1, wherein the mirror is composed of a high gloss polished metallic element.

8. The money clip according to claim 1, wherein the base plate is composed of metal or a metal alloy and the region for forming the mirror is high gloss polished.

9. The money clip according to claim 2, wherein the retaining leg is composed of metal or a metal alloy and the region for forming the mirror is high gloss polished.

10. The money clip according to claim 1, wherein a region of the base plate for forming the mirror is chrome-plated or coated with a mirror varnish.

11. The money clip according to claim 2, wherein a region of the retaining leg for forming the mirror is chrome-plated or coated with a mirror varnish.

12. The money clip according to claim 1, wherein the at least one mirror is disposed on a face of the base plate facing the retaining leg.

13. A money clip for storing banknotes or comparable flatly formed items, including a base plate and at least one retaining leg disposed on the base plate, wherein the retaining leg is formed such that it exerts a clamping function or a retention force in the direction of the base plate, wherein at least one region of the retaining leg is formed as a mirror or comprises a mirror.

14. The money clip according to claim 13, wherein the mirror is composed of a mirror foil or a flatly formed plastic or metallic element with at least one mirrored surface.

15. The money clip according to claim 13, wherein the mirror is composed of a high gloss polished metallic element.

16. The money clip according to claim 13, wherein the retaining leg is composed of metal or a metal alloy and the region for forming the mirror is high gloss polished.

17. The money clip according to claim 13, wherein a region of the retaining leg for forming the mirror is chrome-plated or coated with a mirror varnish.

18. The money clip according to claim 13, wherein the at least one mirror is disposed on a face of the retaining leg facing the base plate.

19. The money clip according to claim 13, wherein the mirror is formed as a separate element to be attached to the retaining leg.

20. The money clip according to claim 13, wherein the retaining leg is connected to the base plate in hinged manner.

21. The money clip according to claim 13, wherein a receiving device for check cards, EC cards, credit cards or comparable electronic cards is formed on a face of the base plate opposite to the retaining leg.

22. The money clip according to claim 12, wherein additionally at least one region of the base plate is formed as a mirror or comprises a mirror.
